(19) United States
(12) Patent Application Publication
(10) Pub. No.: US 2026/0070494 A1
(43) Pub. Date: Mar. 12, 2026

(54) SPEAKER ENCLOSURE, SPEAKER ASSEMBLY, AND SEAT ASSEMBLY

(71) Applicant: Harman Becker Automotive Systems, Inc., Novi, MI (US)

(72) Inventors: Scott Shion MAIDENS, Novi, MI (US); Adam Michael SACHS, Bloomfield Township, MI (US); David MOSSINGTON, Rochester, MI (US)

(21) Appl. No.: 18/883,468

(22) Filed: Sep. 12, 2024

(51) Int. Cl. B60R 11/02; B60R 11/00

(52) U.S. Cl. CPC B60R 11/0223; B60R 2011/0015

(57) ABSTRACT

A speaker enclosure is provided with a first panel sized to attach to a pair of spaced apart side members of a seatback frame, wherein an opening is formed in the first panel and sized to receive a speaker. A second panel is spaced apart from the first panel to collectively define a speaker chamber between the first panel and the second panel, wherein a second opening is formed in the second panel, aligned with the first opening and sized to provide clearance for a magnet of the speaker. A speaker has an axial depth from a flange to a magnet. A depth of the speaker enclosure in a region of the speaker is equal to, or less than, the axial depth of the speaker.

### TECHNICAL FIELD

Various embodiments related to speaker enclosures, speaker assemblies, and seat assemblies.

### BACKGROUND

A subwoofer is a type of loudspeaker designed to reproduce low-frequency sounds, typically ranging from twenty to 200 hertz (Hz). These low frequencies are often referred to as bass. Subwoofers are commonly used in home theater systems, vehicle audio systems, and professional sound setups to enhance the depth and impact of audio, providing a fuller and more immersive listening experience. Subwoofers are often larger than regular speakers and are usually powered by their own amplifier, to produce deep bass tones effectively.

A subwoofer enclosure, also known as a subwoofer box or cabinet, is a specially designed container that houses a subwoofer. A subwoofer enclosure enhances a performance of the subwoofer by controlling how the sound waves are produced and dispersed. There are several types of subwoofer enclosures, each with different designs and purposes.

For example, a sealed enclosure is airtight and provides tight, accurate bass response. Sealed enclosures provide an acoustic suspension, and are known for clear and precise sound, but may not produce as much volume as other types.

According to another example, a ported enclosure may include a vent or port that allows air to move in and out of the enclosure. The ported enclosure provides a bass reflex, and helps increase an efficiency of the subwoofer, by producing a louder and deeper bass output. Ported enclosures can sometimes be less precise than sealed enclosures. Slot-ported enclosures are similar to ported enclosures, but with a slot-shaped port instead of a round one. Slot-ported enclosures can offer more precise tuning and a different acoustic profile.

According to yet another example, a bandpass enclosure has a more complex design with two chambers and a port. Bandpass enclosures are designed to enhance the output at specific frequencies and are often used in situations where very high output levels are desired.

The design and material of the subwoofer enclosure can significantly affect the performance of the subwoofer, impacting factors like bass response, efficiency, and overall sound quality. Properly designing and constructing an enclosure helps ensure that the subwoofer performs optimally and delivers the best possible sound.

Speaker enclosures can be made from a variety of materials, each affecting the sound quality and durability of the speaker in different ways. Wood is often used for high-quality speakers due to its natural acoustic properties. It can be solid wood or plywood, and sometimes MDF (Medium-Density Fiberboard), which is dense and provides good sound damping. MDF is a popular choice due to its density and consistency, which helps reduce unwanted resonances and vibrations. MDF is less expensive than solid wood but still offers good acoustic performance. Plywood is used in some enclosures for its strength and lighter weight compared to solid wood. Plywood also has good acoustic properties but can be less consistent than MDF.

Speaker enclosures can also be fabricated from plastic, such as injection-molded plastics, which are often used in portable speakers. Plastic speaker enclosures can be designed to be lightweight and durable but may not provide the same acoustic performance as wood or MDF. Metal is sometimes used for its durability and modern aesthetic. Metals like aluminum can be used, though they often require additional internal treatments to manage resonances and vibrations. Some high-end enclosures use advanced composites that combine materials to optimize acoustic performance, strength, and weight. Composite material enclosures can include combinations of fibers, resins, and other specialized materials. Fiberglass can be used in some high-end and custom enclosures for its ability to be molded into complex shapes and its strength-to-weight ratio. Fiberglass also has good acoustic properties when properly designed.

Each speaker enclosure material has its own set of advantages and trade-offs in terms of cost, weight, durability, and acoustic performance, so the choice often depends on the specific needs of the speaker design.

In the context of vehicle audio systems, speaker assemblies have been provided throughout the vehicle interior, such as in a dashboard, along vehicle pillars, within door panels, and within head restraints.

### SUMMARY

According to an embodiment, a speaker enclosure is provided with a panel sized to attach to a pair of spaced apart side members of a seatback frame, wherein an opening is formed in the panel and sized to receive a speaker.

According to a further embodiment, the panel is further defined as a first panel. The speaker enclosure is further provided with a second panel spaced apart from the first panel to provide a speaker chamber therebetween.

According to an even further embodiment, the speaker chamber is sized to fit between the pair of spaced apart side members of the seatback frame.

According to another even further embodiment, the first panel and the second panel are spaced apart in a direction of a depth of the speaker enclosure. The speaker enclosure has a width to span a space between the pair of spaced apart side members of the seatback frame. The depth of the speaker enclosure is less than the width.

According to an even further embodiment, the speaker enclosure has a height in an upright direction of the seatback frame. The depth of the speaker enclosure is less than the height.

According to another embodiment, a speaker assembly is provided with a speaker enclosure with a panel sized to attach to a pair of spaced apart side members of a seatback frame, wherein an opening is formed in the panel and sized to receive a speaker. A speaker is installed in the speaker enclosure opening.

According to another embodiment, a seat assembly is provided with a seatback frame with a pair of spaced apart side members and at least one cross member interconnecting the pair of spaced apart side members. A speaker assembly is provided with a speaker enclosure with a panel sized to attach to a pair of spaced apart side members of a seatback frame, wherein an opening is formed in the panel and sized to receive a speaker. A speaker is installed in the speaker enclosure opening. The speaker assembly is fastened to the pair of spaced apart side members.

According to a further embodiment, the speaker assembly is oriented to face rearward of seatback frame.

According to another further embodiment, a trim cover at least partially covers the seatback frame and the speaker assembly, wherein an acoustically transparent region is provided in the trim cover over the speaker.

According to another embodiment, a speaker enclosure is provided with a first panel with a first opening sized to receive a speaker. A second panel is spaced apart from the first panel to collectively define a speaker chamber between the first panel and the second panel, wherein a second opening is formed in the second panel, aligned with the first opening and sized to provide clearance for a magnet of the speaker.

According to a further embodiment, the speaker enclosure is sized to attach to a pair of spaced apart side members of a seatback frame.

According to an even further embodiment, the speaker chamber is sized to fit between the pair of spaced apart side members of the seatback frame.

According to another even further embodiment, the first panel and the second panel are spaced apart in a direction of a depth of the speaker enclosure. The speaker enclosure has a width to span a space between the pair of spaced apart side members of the seatback frame. The depth of the speaker enclosure is less than the width.

According to an even further embodiment, the speaker enclosure has a height in an upright direction of the seatback frame. The depth of the speaker enclosure is less than the height.

According to another embodiment, a speaker assembly is provided with a speaker enclosure with a first panel with a first opening sized to receive a speaker. A second panel is spaced apart from the first panel to collectively define a speaker chamber between the first panel and the second panel, wherein a second opening is formed in the second panel, aligned with the first opening and sized to provide clearance for a magnet of the speaker. A speaker is installed in the first opening.

According to a further embodiment, a seal is provided between the speaker and the second opening.

According to another embodiment, a seat assembly is provided with a seatback frame with a pair of spaced apart side members and at least one cross member interconnecting the pair of spaced apart side members. A speaker assembly is provided with a speaker enclosure with a first panel with a first opening sized to receive a speaker. A second panel is spaced apart from the first panel to collectively define a speaker chamber between the first panel and the second panel, wherein a second opening is formed in the second panel, aligned with the first opening and sized to provide clearance for a magnet of the speaker. A speaker is installed in the first opening. The speaker assembly is fastened to the pair of spaced apart side members.

According to another embodiment, a speaker assembly is provided with a speaker with a flange, a cone extending from the flange, a magnet attached to the cone, and a diaphragm attached to the flange. The speaker has an axial depth from the flange to the magnet. A speaker enclosure has an opening sized to receive the flange of the speaker, wherein a depth of the speaker enclosure in a region of the speaker is equal to, or less than, the axial depth of the speaker.

According to a further embodiment, the speaker enclosure is provided with a first panel sized to attach to a pair of spaced apart side members of a seatback frame, wherein the first opening is formed in the panel.

According to an embodiment, a seat assembly is provided with a seatback frame with a pair of spaced apart side members and at least one cross member interconnecting the pair of spaced apart side members. A speaker assembly is provided with a speaker with a flange, a cone extending from the flange, a magnet attached to the cone, and a diaphragm attached to the flange. The speaker has an axial depth from the flange to the magnet. A speaker enclosure has an opening sized to receive the flange of the speaker, wherein a depth of the speaker enclosure in a region of the speaker is equal to, or less than, the axial depth of the speaker. The speaker assembly is fastened to the pair of spaced apart side members.

### BRIEF DESCRIPTION OF THE DRAWINGS

FIG. 1 is a rear perspective view of a seat assembly according to an embodiment;

FIG. 2 is a rear perspective view of the seat assembly of FIG. 1, illustrated partially disassembled with a speaker assembly, according to an embodiment;

FIG. 3 is a rear perspective view of the seat assembly of FIG. 1, illustrated partially disassembled with a speaker of the speaker assembly of FIG. 2;

FIG. 4 is a front perspective view of the speaker assembly of FIG. 2;

FIG. 5 is a partial section of the seat assembly of FIG. 1, taken along section line 5-5 in FIG. 3; and

FIG. 6 is a partial section view of the speaker assembly of FIG. 2, taken along section line 6-6 in FIG. 4.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

It will also be understood that, although the terms first, second, etc. are, in some instances, used herein to describe various elements, these elements should not be limited by these terms. These terms are only used to distinguish one element from another. For example, a first panel could be termed a second panel, and, similarly, a second panel could be termed a first panel, without departing from the scope of the various described embodiments. The first panel and the second panel are both panels, but they are not the same panel. The terms first, second, etc. are utilized to denote an order of introduction and to distinguish between different elements with similar structure.

In the context of vehicle interiors, speaker assemblies are often installed in locations that discretely house and support the speaker assemblies while providing a tuned and enjoyable audio experience to occupants within the vehicle. Vehicles may include land vehicles, aircraft, or watercraft. Common vehicle interior speaker locations include dashboards, instrument panels, door panel assemblies, head restraints, and beneath seat assemblies. Subwoofer speaker assemblies often require a larger enclosure than other speakers, thereby requiring a significant volume to house and balance the subwoofer.

There is a market desire to reduce an overall size of vehicles, for energy efficiency, compactness, and the like. These size reductions could reduce overall interior dimensions within the vehicles. In order to reduce an overall vehicle body size, without significant decreases to vehicle interiors, speaker assemblies can be relocated in order to optimize seating and interior volume within a vehicle.

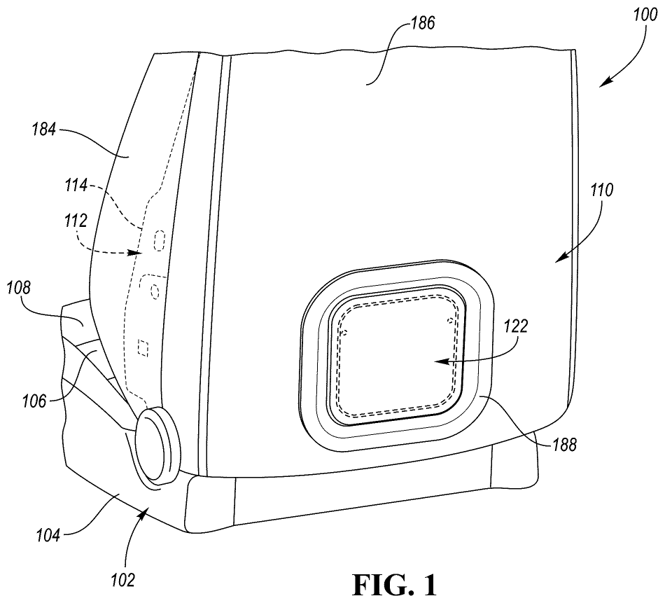

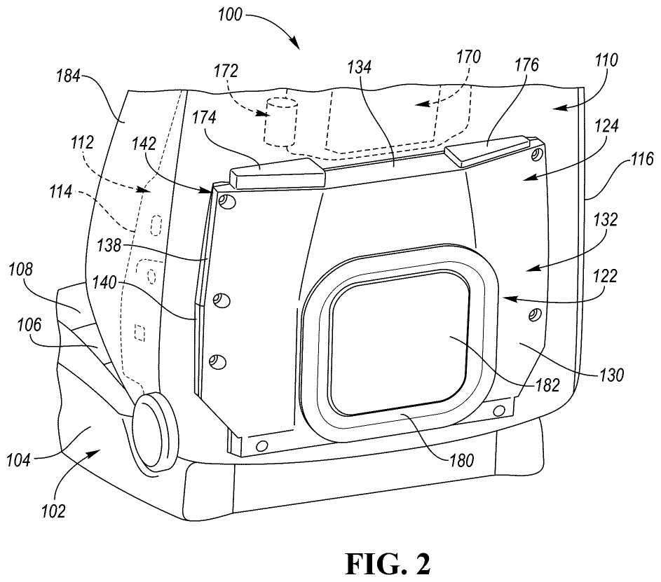

FIG. 1 illustrates a seat assembly 100 according to an embodiment. The seat assembly 100 may be a front row seat, a rear row seat, or the like. As illustrated in FIGS. 1 and 2, the seat assembly 100 includes a seat bottom subassembly 102 to receive and support a pelvis, hips, and thighs of a seated occupant. The seat bottom subassembly 102 includes a seat bottom frame 104 that is adapted to be affixed to a vehicle body, such as a vehicle floor. The seat bottom subassembly 102 includes a cushion 106 to provide padded support and comfort to the occupant. A seat bottom trim cover 108 is provided over the cushion 106 to contain and conceal the cushion 106.

Referring now to FIGS. 1-3 the seat assembly 100 includes a seatback subassembly 110 that extends upright relative to the seat bottom subassembly 102. The seatback subassembly 110 is sized to receive and support pelvis, lumbar, thoracic, and shoulder regions of the seated occupant. The seatback subassembly 110 may be supported by the seat bottom subassembly 102. Further, the seatback subassembly 110 may be pivotally connected to the seat bottom subassembly 102. According to other embodiments, the seatback subassembly 110 may be supported by the vehicle body.

The seatback subassembly 110 includes a seatback frame 112. The seatback frame 112 may be formed as a weldment of stamped sheet metal members, according to an embodiment. The seatback frame 112 may be formed from polymeric materials, according to another embodiment, which may be carbon fiber reinforced according to another embodiment. Any suitable seat frame 112 material may be employed, as is known in the art.

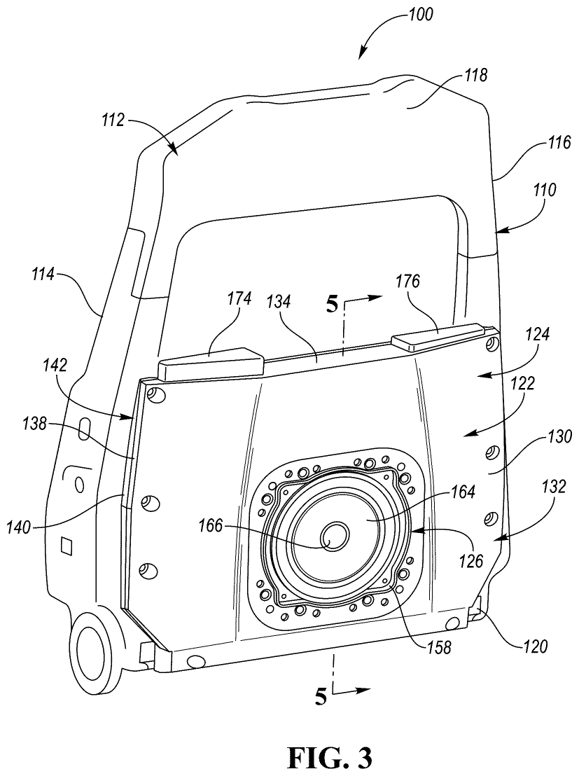

The seatback frame 112 is sized to support the seated occupant as well as various comfort, entertainment, and wellness subassemblies. The seatback frame 112 includes a pair of spaced apart upright side members 114, 116. As illustrated in FIG. 3, the seatback frame 112 also includes an upper cross member 118 and a lower cross member 120 interconnecting the side members 114, 116.

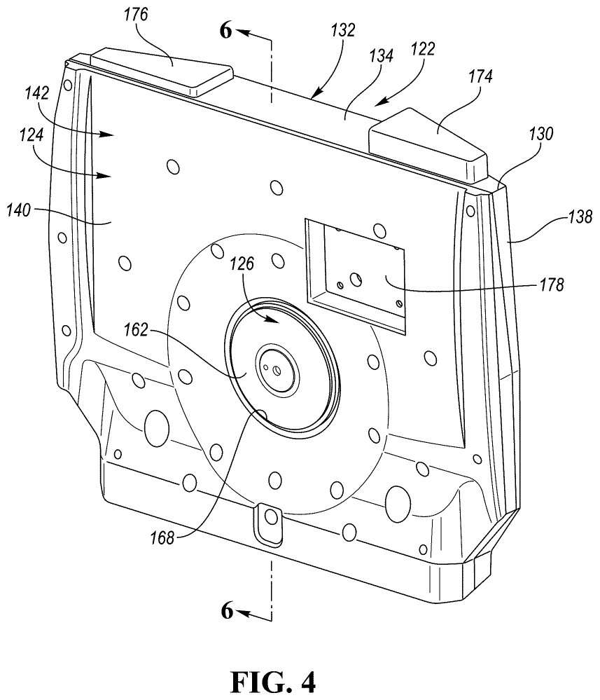

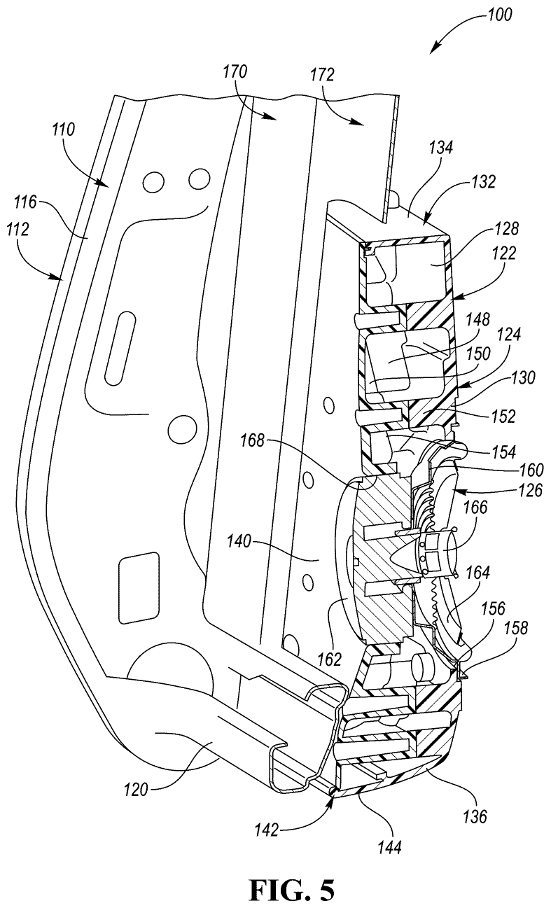

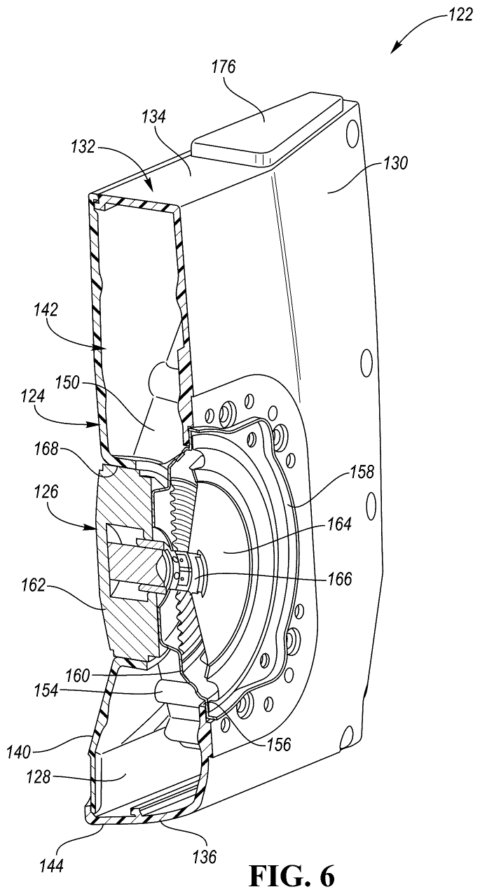

With reference again to FIGS. 1-3, the seat assembly 100 includes a speaker assembly 122, as a subassembly 122 of the seat assembly 100. The speaker subassembly 122 is attached to the seatback frame 112. The speaker subassembly 122 includes a speaker enclosure 124 and a speaker 126, which are also illustrated in FIGS. 4-6. According to a depicted embodiment, the speaker 126 is a subwoofer 126. Subwoofers 126 typically require a speaker chamber with a significant volume to house the subwoofer 126 and to provide adequate response, efficiency, sound quality from the speaker subassembly 122. Accordingly, the speaker enclosure 124 is sized to provide sufficient volume to a speaker chamber 128 or resonance chamber 128 within the enclosure 124, as illustrated in FIGS. 5 and 6.

Conventionally, speaker assemblies may be located throughout an automotive interior with multiple speaker assemblies, which may be disposed within a door panel, under the seat assembly, within a headrest of the seat assembly, or the like. The multiple speaker assemblies require multiple speaker enclosures, which may collectively occupy more volume than the subwoofer enclosure 124. The speaker subassembly 122 offers a packaging solution for speakers 126 in seatback subassemblies 110. As will be explained the speaker subassembly 122 leaves more space for the occupant in the seat assembly 100 and for an occupant seated behind the seat assembly 100.

By placing the subwoofer 126 in the seatback subassembly 110, a subwoofer is not required in a door panel assembly. Design factors for mounting a subwoofer 126 in a seat assembly 100, is optimizing comfort of the occupants while providing high quality acoustic output. Placement of the subwoofer 126 too close to the occupant seated in the seat assembly 100 may cause discomfort to the seated occupant from vibrations and may compromise seat jounce. Conversely, orientation of a speaker assembly too far rearward within a seat assembly may create an uncomfortable sitting arrangement for the occupant seated rearward of the seat assembly 100 due to compromised leg room. Additionally, the speaker may be at risk of damage from contact with knees of the rear seated occupant.

Placement of the subwoofer 126 in the enclosure 124 facing rearward from the seatback frame 112 provides an acoustic output that is more direct, and more efficient than prior art subwoofer placement. Due to this efficiency, the size of the subwoofer 126 may be optimized, and therefore, smaller than indirect prior art subwoofers. Optimizing the efficiency of the subwoofer 126 removes cost and weight from the vehicle. Removing the subwoofer 126 from the door assembly permits other features in the door assembly, thereby reducing cost, while increasing safety. Likewise, the subwoofer 126 can be preassembled into the seat assembly 100 to minimize installation complexity at an original equipment manufacturer, whereby the seat assembly 100 can be installed directly with a wiring connection minimized to one terminal.

Referring again to FIGS. 2 and 3, the enclosure 124 is sized to optimize compactness. The enclosure 124 is fastened to the pair of side members 114, 116 of the seatback frame 112. The enclosure 124 is formed from a structurally rigid polymeric material, according to some embodiments, such as plastic or fiberglass reinforced plastic. Of course, other suitable enclosure materials may be employed, such as wood, MDF, plywood, metal, or the like. The enclosure 124 may be molded, fabricated from additive manufacturing such as three-dimensional printing, machined, cast, or otherwise suitably manufactured.

With reference now to FIGS. 2-6, the speaker enclosure 124 includes a first panel or outer panel 130. The outer panel 130 has a contour associated with a typical seatback and therefore is relatively convex. In the depicted embodiment, the outer panel 130 is formed on an enclosure portion 132, which includes an upper rim 134, a lower rim 136, and a pair of side rims 138 provided about a periphery of the outer panel 130, and extending from the panel 130 in a forward direction of the seat assembly 100. The speaker enclosure 124 also includes a second panel 140, or inner panel 140. The inner panel 140 provides an inner enclosure portion 142 which cooperates with the outer enclosure portion 132. The inner panel 140 contacts the upper rim 134 and the side rims 138 of the outer enclosure portion 132. The inner enclosure portion 142 also includes a lower rim 144 that extends rearward from the inner panel 140 to engage the outer lower rim 136 as depicted in FIGS. 5 and 6.

With continued reference to FIGS. 5 and 6, the outer panel 130 and the inner panel 140 are spaced apart to provide the speaker chamber 128 therebetween. The mating surfaces of the outer panel 130 and the inner panel 140 may be sealed with a sealant or gasket to seal the resonance chamber 128. The enclosure portions 132, 142 may include a plurality of ribs 148, 150 extending from the panels 130, 140 for additional structural enhancement of the panels 130, 140. The ribs 148, 150 may also be aligned to contact each other. A plurality of fastener bosses 152, 154 may each extend inward from the panels 130, 140 to contact each other within the speaker chamber 128. The bosses 152, 154 to receive threaded fasteners to fasten the inner enclosure portion 142 to the outer enclosure portion 132.

As illustrated in FIGS. 5 and 6, an opening 156 is formed through the outer panel 130, which is sized to receive the subwoofer 126. As depicted in FIGS. 3, 5, and 6, the subwoofer 126 is a cone speaker 126, with a flange 158 fastened to the outer panel 130. A sealant or gasket may be provided between the flange 158 and the outer panel 130 to seal the joint. In FIGS. 5 and 6, a speaker cone 160, or a basket 160, extends from the flange 158 and into the speaker chamber 128. A magnet 162 is connected to the cone 160. A diaphragm 164 also extends from the flange 158 to a driver 166 of the speaker 126. An aperture 168 is formed through the inner panel 140 aligned with the speaker opening 156 of the outer panel 130. The inner panel aperture 168 is sized to receive the magnet 162 of the speaker 126 to provide clearance for the magnet 162. A sealant, gasket, or other seal may also be provided between the magnet 162 and the aperture 168.

The speaker enclosure 124 optimizes a volume for the subwoofer 126 without compromising space within the seatback subassembly 110. For example, the enclosure 124 may provide four liters of speaker chamber 128 volume, while minimizing the depth. Under one example, the enclosure 124 spans a width of the side members 114, 116 of the seatback frame 112; and the speaker chamber 128 is sized to fit between the side members 114, 116. In order to minimize a depth of the enclosure 124 in an axial direction of the speaker 126, a height and a width of the enclosure 124 are enlarged relative to the depth; and the height and the width of the enclosure 124 are larger than the depth. The depth of enclosure 124 is oriented in a direction along which the outer panel 130 and the inner panel 140 are spaced apart. The width of the enclosure 124 is oriented in a lateral direction from one side member 114 to another 116. The height of the enclosure 124 is oriented in an upright direction of the seatback frame 112, extending upward from the lower cross member 120 of the seatback frame 112. In order to minimize the depth of the enclosure 124, the magnet 162 extends through the inner panel 140 so that the depth is less than, or equal to, the axial depth of the subwoofer 126. In other words, the enclosure 124 is as thin as permitted for the particular subwoofer 126.

All connections of the enclosure 124 with the speaker 126 and the seatback frame 112 may be sealed to provide back pressure to the speaker 126. Additionally, damping material may be provided at these connections to reduce vibrations to the seatback frame 112. The enclosure 124 can be tuned to determine a natural resonance, and to reduce unwanted vibrations.

The speaker subassembly 122 provides clearance for various other features within the seat assembly 100. For example, the seat assembly 100 may be a wellness seat assembly 100 with various wellness features, such as massage, heating, cooling, adjustment, or the like. For example, a lumbar mechanism 170 may be provided in the seat assembly 100 as illustrated in FIGS. 2 and 5. Additionally a massage feature may be driven by a massage motor 172. Speaker chamber extensions 174, 176 are provided on the upper rim 134 of the outer enclosure portion 132 to extend the speaker chamber 128 above the upper rim 134 into regions that do not interfere with other mechanisms of the seat assembly 100. As illustrated in FIG. 4, a receptacle 178 is formed into the inner panel 140 to receive and support a biometric measurement device in the seat assembly 100, which is used to measure and/or monitor one or more biometric features of the seated occupant.

With reference to FIG. 2, a reflector 180 is oriented around the subwoofer 126 to direct the acoustic output of the subwoofer. A speaker grille 182 is provided over the subwoofer 126 to protect the subwoofer from inadvertent contact. As illustrated in FIGS. 1 and 2 a seatback cushion 184 is installed on the seatback frame 112 thereby enclosing the inner panel 140 of the speaker subassembly 122. FIG. 1 illustrates a trim cover 186 displaced over the seatback frame 112 and the speaker subassembly 122 to conceal the speaker subassembly 122. The trim cover 186 may be formed from leather, vinyl, fabric, a polymeric material, or the like. The trim cover 186 includes an acoustically transparent region 188 oriented over the subwoofer 126 to permit acoustic vibrations to egress the trim cover 186.

While various embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A speaker enclosure comprising a panel sized to attach to a pair of spaced apart side members of a seatback frame, wherein an opening is formed in the panel and sized to receive a speaker.

2. The speaker enclosure of claim 1, wherein the panel is further defined as a first panel; and
wherein the speaker enclosure further comprises a second panel spaced apart from the first panel to provide a speaker chamber therebetween.

3. The speaker enclosure of claim 2, wherein the speaker chamber is sized to fit between the pair of spaced apart side members of the seatback frame.

4. The speaker enclosure of claim 2, wherein the first panel and the second panel are spaced apart in a direction of a depth of the speaker enclosure;
wherein the speaker enclosure has a width to span a space between the pair of spaced apart side members of the seatback frame; and
wherein the depth of the speaker enclosure is less than the width.

5. The speaker enclosure of claim 4, wherein the speaker enclosure has a height in an upright direction of the seatback frame; and
wherein the depth of the speaker enclosure is less than the height.

6. A speaker assembly comprising:
the speaker enclosure of claim 1; and
a speaker installed in the speaker enclosure opening.

7. A seat assembly comprising:
a seatback frame comprising a pair of spaced apart side members and at least one cross member interconnecting the pair of spaced apart side members; and
the speaker assembly of claim 6, fastened to the pair of spaced apart side members.

8. The seat assembly of claim 7, wherein the speaker assembly is oriented to face rearward of seatback frame.

9. The seat assembly of claim 7 further comprising a trim cover at least partially covering the seatback frame and the speaker assembly, wherein an acoustically transparent region is provided in the trim cover over the speaker.

10. A speaker enclosure comprising:
a first panel with a first opening sized to receive a speaker; and
a second panel spaced apart from the first panel to collectively define a speaker chamber between the first panel and the second panel, wherein a second opening is formed in the second panel, aligned with the first opening and sized to provide clearance for a magnet of the speaker.

11. The speaker enclosure of claim 10, wherein the speaker enclosure is sized to attach to a pair of spaced apart side members of a seatback frame.

12. The speaker enclosure of claim 11, wherein the speaker chamber is sized to fit between the pair of spaced apart side members of the seatback frame.

13. The speaker enclosure of claim 11, wherein the first panel and the second panel are spaced apart in a direction of a depth of the speaker enclosure;
wherein the speaker enclosure has a width to span a space between the pair of spaced apart side members of the seatback frame; and
wherein the depth of the speaker enclosure is less than the width.

14. The speaker enclosure of claim 13, wherein the speaker enclosure has a height in an upright direction of the seatback frame; and
wherein the depth of the speaker enclosure is less than the height.

15. A speaker assembly comprising:
the speaker enclosure of claim 10; and
a speaker installed in the first opening.

16. The speaker assembly of claim 15 further comprising a seal between the speaker and the second opening.

17. A seat assembly comprising:
a seatback frame comprising a pair of spaced apart side members and at least one cross member interconnecting the pair of spaced apart side members; and
the speaker assembly of claim 15 fastened to the pair of spaced apart side members.

18. A speaker assembly comprising:
a speaker comprising a flange, a cone extending from the flange, a magnet attached to the cone, and a diaphragm attached to the flange, the speaker having an axial depth from the flange to the magnet; and
a speaker enclosure having an opening sized to receive the flange of the speaker, wherein a depth of the speaker enclosure in a region of the speaker is equal to, or less than, the axial depth of the speaker.

19. The speaker assembly of claim 18, wherein the speaker enclosure comprises a first panel sized to attach to a pair of spaced apart side members of a seatback frame, wherein the first opening is formed in the first panel.

20. A seat assembly comprising:
a seatback frame comprising a pair of spaced apart side members and at least one cross member interconnecting the pair of spaced apart side members; and
the speaker assembly of claim 18 fastened to the pair of spaced apart side members.
